(19) United States
(12) Patent Application Publication
(10) Pub. No.: US 2009/0150969 A1
(43) Pub. Date: Jun. 11, 2009

(54) Filtering Policies to Enable Selection of Policy Subsets

(76) Inventors: Douglas B. Davis, Raleigh, NC (US); Christopher B. Ferris, Northbridge, MA (US); Peter D. Niblett, Whitchurch (GB)

Correspondence Address: HAMILTON & TERRILE, LLP;IBM RSW, P.O. BOX 203518, AUSTIN, TX, 78720, US

(21) Appl. No.: 11/950,473

(22) Filed: Dec. 5, 2007

(51) Int. Cl. G06F 17/00

(52) U.S. Cl. 726/1

(57) ABSTRACT

A policy filter enables selection of a subset policy alternative that meets certain criteria from amongst a set of policy alternatives without having to specify the entire contents of the alternative to be selected. More specifically, the policy filter simplifies the process of selecting an appropriate alternative from amongst a set of available policy alternatives when the selection criteria comprises only a subset of the behaviors implied by an alternative by reducing the set of available alternatives to those that satisfy a certain criteria.

### BACKGROUND OF THE INVENTION

The present invention relates in general to data processing systems and in particular to using computers to filter policies to enable selection of policy subsets.

It is known to use Web services to provide interoperability across a heterogeneous world of platforms, software technologies, and proprietary assets. With Web services it is possible to integrate disparate assets and share data so that information can be abstracted away from the assets themselves.

An architectural context for the deployment, operation, and management of a Web service is instantiated in a Service Oriented Architecture (SOA) A Web services policy enables multiple policy alternatives (i.e., collections of policy assertions that each implies a certain behavior to be affected in the context of an interchange governed by the policy). These alternatives can be simple (e.g., describing a single behavior) or very complex (e.g., describing multiple behaviors). As an example, a policy alternative might indicate that messages should be secured at both the transport and message level using Web Services Security (WS-Security), indicate the type of security token to be used to authenticate a user, and specify that messages should be sent reliably using WS-Reliable Messaging.

However, user management of Web services policies can be complex. For example, a service provider may provide a policy that includes a plurality of alternatives, two that include an assertion that specifies that messages should be sent reliably using WS-Reliable Messaging that each have different security characteristics and three alternatives that do not include the reliable messaging assertion. A service consumer might have a policy that when intersected with the provider's policy would result in a policy that contains three of the four alternatives, including one that specifies that messages be sent reliably, in addition to some other quality of service behaviors such as security. The service consumer is still faced with the need to sort out which of the remaining three policy alternatives should be used.

### BRIEF SUMMARY OF THE INVENTION

In one embodiment, the invention relates to a method for filtering policies to enable selection of a subset of policy alternatives which includes receiving a policy, and filtering a set of alternatives in the policy to provide a subset of policy alternatives. The subset of policy alternatives matches the filtering criteria applied during the filtering.

In another embodiment, the invention relates to a computer program product for filtering policies to enable selection of a subset of policy alternatives. The computer program product includes a computer usable medium having computer usable program code embodied therewith. The computer usable program code includes computer usable program code configured to receiving a policy, and computer usable program code configured to filter a set of alternatives in the policy to provide a subset of policy alternatives. The subset of policy alternatives matches the filtering criteria applied during the filtering.

In another embodiment, the invention relates to a system which includes a processor, a data bus coupled to the processor, and a module for filtering policies to enable selection of a subset of policy alternative. The module for filtering policies includes a module for receiving a policy, and a module for filtering a set of alternatives in the policy to provide a subset of policy alternatives. The subset of policy alternatives matches the filtering criteria applied during the filtering.

### BRIEF DESCRIPTION OF THE SEVERAL VIEWS OF THE DRAWINGS

FIG. 1 depicts an exemplary client computer in which the present invention may be implemented;

FIG. 2 depicts a block diagram of an example system which includes a policy filter system.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

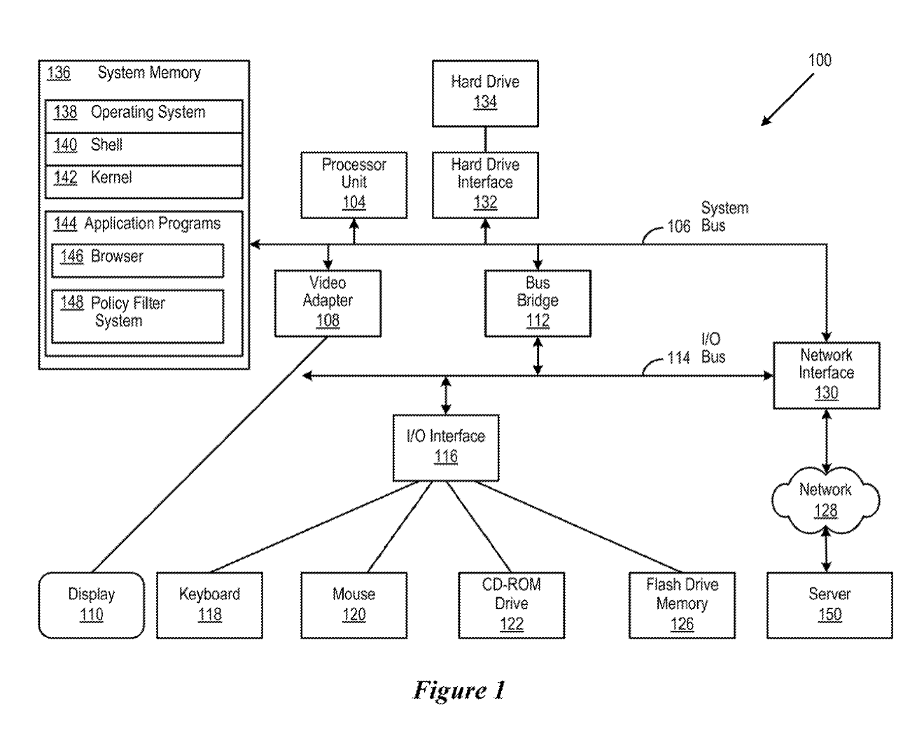

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via Bus Bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, and flash memory drive 126. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as a Local Area Network (LAN), an Ethernet, or a Virtual Private Network (VPN). In one embodiment, server 150 is configured similarly to computer 100.

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Data that populates system memory 136 includes Operating System (OS) 138, application programs 144, and database 137. Database 137 includes multiple records of standardized business data. In another embodiment, database 137 may instead be stored in server 150.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes graphical user interface (GUI) 143 and kernel 142, which includes lower levels of functionality for OS 138. Kernel 142 provides essential services required by other parts of OS 138 and application programs 144. The services provided by kernel 142 include memory management, process and task management, disk management, and I/O device management.

Application programs 144 include browser 146 and policy filter system 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Policy Filter System 148 performs the functions as discussed below. In one embodiment, Policy Filter System 148 is called via an Application Programming Interface (API).

The hardware elements depicted in computer 102 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

The policy filter system 148 includes code for implementing the processes described below. As noted above, the policy filter system 148 can be downloaded to a client computer from service provider server 150. Additionally, in one aspect of the invention, service provider server 150 performs all of the functions associated with the present invention (including execution of the policy filter system 148), thus freeing a client computer 102 from using its resources.

The policy filter system 148 enables selection of a subset policy alternative that meets certain criteria from amongst a set of policy alternatives without having to specify the entire contents of the alternative to be selected. More specifically, the policy filter system and method simplifies the process of selecting an appropriate alternative from amongst a set of available policy alternatives when the selection criteria comprises only a subset of the behaviors implied by an alternative by reducing the set of available alternatives to those that satisfy a certain criteria.

In certain embodiment, the policy filter system 148 enables composition of complex selection criteria using XML path language (e.g., XPath1.0). However, the representation of a policy expression is unordered, which means that certain aspects of the XPath language (or any other similar technology) cannot be applied with expectation of consistent results. For example, the XPath language allows selection of an XML element based on an ordinal position in a document. Thus, use of the position XPath operator is inappropriate. Additionally, because policy expressions have many equivalent representations that are structurally disjoint, it is desirable to constrain the filtering expression to a canonical representation. Accordingly, the policy filter system 148 limits selection criteria to be a predicate expression, thereby simplifying the selection criteria expression to one that can be as simple as an XML Qualified Name (QName) e.g. ‘foo:Bar’, rather than something as complex as: ‘/wsp:Policy/wsp:ExactlyOne/wsp:All[foo:Bar]’. Given that the policies might be expressed using the Web Services Policy 1.5 compact format, the full XPath expression might not be intuitive to developers of the policy expression. The predicate expression provides a set of criteria that must be satisfied in the context of a full XPath expression. Thus, the policy filter system 148 evaluates the predicate expression against each possible alternative.

It should be understood that at least some aspects of the present invention may alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

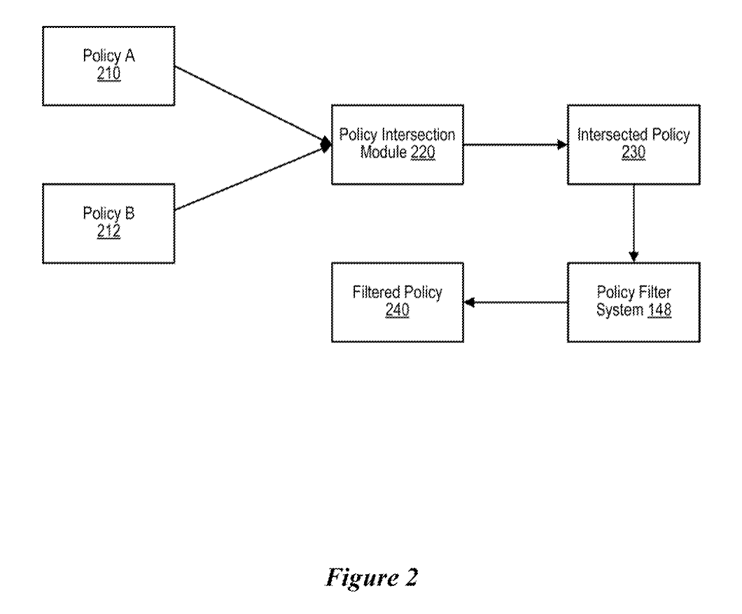

With reference now to FIG. 2, a block diagram of a Web services architecture which includes the policy filter system 148 is shown. More specifically, a Web services architecture 200 can receive a plurality of policies (e.g., policy A 210 and policy B 212). Within the Web services architecture a policy intersection operation is performed by a policy intersection module 220. An example policy intersection operation is described within the WS Policy 1.5 Framework Specification. The intersected policy 230 is provided to the policy filter system 148 to provide a filtered policy 240.

More specifically, the policy filter system 148 provides an XML vocabulary that allows for the expression of a predicate expression that when applied to the result 230 of policy intersection can reduce the set of available alternatives to those that satisfy the criteria expressed in the predicate expression. The predicate expression is the set of criteria that must be matched to select the subset of alternatives from the set of alternatives in the intersected policy. The format of the policy filter expression is an XML element that contains the predicate expression, typically an XML Qualified Name (QName) of the policy assertion that represents the desired behavior to be selected. In certain embodiments, the policy filter may be expressed as
<PolicyFilter dialect=“xs:anyURI”>[predicate expression]</PolicyFilter>

Using this policy filter expression, an example policy filter might be:

```
        <PolicyFilter xmlns:wsrmp=“http://docs.oasis-open.org/ws-
rx/wsrmp/200702”
            dialect=“http://www.w3.org/TR/1999/REC-xpath-
19991116”>wsrmp:RMAssertion</PolicyFilter>
```

Such a policy filter expression selects a set of policy alternatives that contain a wsrmp:RMAssertion. For example, the policy expression:

```
        <wsp:Policy>
            <wsp:ExactlyOne>
                <wsp:All>
                    <wsrmp:RMAssertion
wsp:Optional=“true”/>
                    <wsat:ATAssertion wsp:Optional=“true”/>
                </wsp:All>
            </wsp:ExactlyOne>
        </wsp:Policy>
```

Is normalized to:

```
<wsp:Policy>
    <wsp:ExactlyOne>
    <wsp:All> <!-- Alternative #1 (RM+Tx) -->
<wsrmp:RMAssertion/>
<wsat:ATAssertion/>
    </wsp:All>
    <wsp:All> <!-- Alternative #2 (just RM) -->
        <wsrmp:RMAssertion/>
    </wsp:All>
    <wsp:All> <!-- Alternative #3 (just Tx) -->
<wsat:ATAssertion/>
    </wsp:All>
    <wsp:All/> <!-- Alternative #4 (no RM or Tx) -->
</wsp:ExactlyOne>
</wsp:Policy>
```

When the policy filter is applied via the policy filter system 148, the policy filter system 148 yields alternatives 1 and 2 (the alternatives that include the RMAssertion). Thus, the resulting equivalent policy expression (i.e., the filtered policy 240) becomes:

```
<wsp:Policy>
    <wsp:All> <!-- Alternative #1 (RM+Tx) -->
        <wsrmp:RMAssertion/>
        <wsat:ATAssertion/>
    </wsp:All>
    <wsp:All> <!-- Alternative #2 (just RM) -->
        <wsrmp:RMAssertion/>
    </wsp:All>
    </wsp:Policy>
```

The predicate expression is composed in an XPath 1.0 expression as follows:
/wsp:Policy/wsp:ExactlyOne/wsp:All[<predicate expression>]

This predicate expression is evaluated against the result of policy intersection 230.

There are a plurality of implementations of by which the policy filter is provided, or obtained, by a user. For example, a WS-Policy Attachment mechanism may be used to associate a Policy Filter with a well defined subject. The well defined subject might be obtained via an out-of-bands communication mechanism, included within application data, included as a simple object access protocol (SOAP) Header or embedded within an Endpoint Reference. An example of a SOAP Header is included within the W3C SOAP specification and of an endpoint reference is included within the WS Policy 1.5 Framework Specification.

Additionally, a policy filter could also be placed in any of a plurality of locations, but without the WS-PolicyAttachment mechanism.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession maybe executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
receiving a policy; and,
filtering a set of alternatives in the policy to provide a subset of policy alternatives, the subset of policy alternatives matching the filtering criteria applied during the filtering.

2. The method of claim 1 wherein:
the filtering criteria comprise a predicate expression of a filtering expression.

3. The method of claim 1 further comprising:
receiving a plurality of policies;
performing a policy intersection operation of the plurality of policies to provide an intersected policy; and,
filtering a set of alternatives in the intersected policy to provide the subset of policy alternatives.

4. The method of claim 1 wherein:
the policy is expressed using a Web services policy.

5. The method of claim 1 wherein:
the filtering criteria comprise an extended markup language (XML) qualified name.

6. The method of claim 1 further comprising:
obtaining the policy filter criteria via a Web services policy attachment mechanism; and,
associating the policy filter criteria with a well defined subject.

7. A computer program product comprising:
a computer usable medium having computer usable program code embodied therewith, the computer usable program code comprising:
computer usable program code configured to receive a policy; and,
computer usable program code configured to filter a set of alternatives in the policy to provide a subset of policy alternatives, the subset of policy alternatives matching the filtering criteria applied during the filtering.

8. The computer program product of claim 7 wherein:
the filtering criteria comprise a predicate expression of a filtering expression.

9. The computer program product of claim 7 wherein the computer usable program code further comprises:
computer usable program code configured to receive a plurality of policies;
computer usable program code configured to perform a policy intersection operation of the plurality of policies to provide an intersected policy; and,
computer usable program code configured to filter a set of alternatives in the intersected policy to provide the subset of policy alternatives.

10. The computer program product of claim 7 wherein:
the policy is expressed using a Web services policy.

11. The computer program product of claim 7 wherein:
the filtering criteria comprise an extended markup language (XML) qualified name.

12. The computer program product of claim 7 wherein the computer usable program code further comprises:
computer usable program code configured to obtain the policy filter criteria via a Web services policy attachment mechanism; and,
computer usable program code configured to associate the policy filter criteria with a well defined subject.

13. A system comprising:
a processor;
a data bus coupled to the processor; and
a module for filtering policies to enable selection of a subset of policy alternative, the module for filtering policies comprising:
a module for receiving a policy; and,
a module for filtering a set of alternatives in-the policy to provide a subset of policy alternatives, the subset of policy alternatives matching the filtering criteria applied during the filtering.

14. The system of claim 13 wherein:
the filtering criteria comprise a predicate expression of a filtering expression.

15. The system of claim 13 wherein the module for filtering policies further comprises:
a module for receiving a plurality of policies;
a module performing a policy intersection operation of the plurality of policies to provide an intersected policy; and,
a module filtering a set of alternatives in the intersected policy to provide the subset of policy alternatives.

16. The system of claim 13 wherein:
the policy is expressed using a Web services policy.

17. The system of claim 13 wherein:
the filtering criteria comprise an extended markup language (XML) qualified name.

18. The system of claim 13 wherein the module for filtering policies further comprises:
a module for obtaining the policy filter criteria via a Web services policy attachment mechanism; and,
a module for associating the policy filter criteria with a well defined subject.
